(19) United States
(12) Patent Application Publication
(10) Pub. No.: US 2009/0158009 A1
(43) Pub. Date: Jun. 18, 2009

(54) ELECTRONIC EQUIPMENT AND CONTROL METHOD

(75) Inventor: Kazuo Sasama, Kanagawa (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/330,888

(22) Filed: Dec. 9, 2008

Related U.S. Application Data
(60) Provisional application No. 61/013,465, filed on Dec. 13, 2007.

(51) Int. Cl. G06F 15/76; G06F 9/02

(52) U.S. Cl. 712/31; 712/E09.002

(57) ABSTRACT

Plural CPUs are provided, and when a first CPU of the plural CPUs is a master, the other CPU operates as a slave. Also, plural memories are provided including a memory that operates and is used for first processing when the master CPU operates and a memory that operates and is used for second processing when the slave CPU operates. Every time an OS (Operating System) starts, the CPU to serve as a master is sequentially switched, then the remaining CPU is caused to serve as a slave, and the memories used for the first processing and the second processing are sequentially switched.

### CROSS-REFERENCE TO RELATED APPLICATION

This application is based upon and claims the priority of U.S. Provisional Application No. 61/013,465, filed on Dec. 13, 2007, the entire contents of which are incorporated herein by reference.

### TECHNICAL FIELD

The present invention relates to an electronic equipment that operates in a power-saving mode, and particularly to an image forming apparatus such as an MFP (Multi-Function Peripheral), which is a digital multi-function machine, or a printer, and a control method.

### BACKGROUND

In a conventional image forming apparatus, for example, in an MFP, print data inputted from a client PC (Personal Computer) or the like is usually in the PDL (Page Description Language) format. To actually print PDL-format data, it is necessary to convert this data to bitmap-format data. To this end, a function called RIP (Raster Image Processor) is provided.

The RIP function is to convert PDL-format data to bitmap-format data (also referred to as raster-format data or image data). However, since the RIP function requires high-performance hardware, it is necessary to extend the memory capacity and enhance the processing capability of the CPU.

Therefore, in the MFP, on the assumption of carrying out the RIP function, an extended memory is provided in addition to a standard memory used for ordinary operations (for example, scanning and copying) Also an additional CPU or CPUs are provided to form a multiple-CPU configuration. When the RIP function is carried out, data is converted by using the extended memory and the additional CPU(s).

JP-A-2003-280107 discloses an image forming apparatus having a controller that switches from a normal mode to a standby mode if image data is not transmitted from the RIP.

Meanwhile, in the MFP with the RIP function, when carrying out ordinary processing (scanning or copying) other than the RIP function, the memory of the standard memory size suffices and therefore the extended memory that is additionally provided for the RIP function wastes power. Moreover, since plural CPUs are constantly usable irrespective of whether the MFP has the RIP function or not, the CPUs waste power as well if processing other than the RIP function is carried out.

When plural (for example, two) CPUs are used, one CPU serves as a master and the other CPU serves as a slave. These CPUs are not used in the same proportion. Similarly, the standard memory and the extended memory are not used in the same proportion. Therefore, the CPU and memory that are used more frequently are used for a longer time and reach their device life faster. This causes a problem that the overall life of the MFP system becomes shorter.

### SUMMARY

An object of the invention is to provide an electronic equipment with reduced power consumption.

According to an aspect of the present invention, there is provided an electronic equipment including: plural CPUs, wherein when a first CPU of the plural CPUs is a master, the other CPU is a slave; plural memories provided corresponding to the plural CPUs, the plural memories including a memory that operates and is used for first processing when the master CPU operates, and a memory that operates and is used for second processing when the slave CPU operates; and a controller that sequentially switches the CPU to serve as a master of the plural CPUs, then causes the remaining CPU to serve as a slave and sequentially switches the memories used for the first processing and the second processing, every time an OS (Operating System) starts.

### DESCRIPTION OF THE DRAWINGS

FIG. 1 is a view showing the configuration of an embodiment of an electronic equipment (image forming apparatus).

FIG. 2 is a block diagram showing the circuit configuration of the image forming apparatus.

FIG. 3 is a block diagram showing an example of a control unit of the image forming apparatus.

FIG. 4A and FIG. 4B are memory maps of memories used in FIG. 3.

FIG. 5A and FIG. 5B are explanatory views of a first operation of the control unit of FIG. 3.

FIG. 6A and FIG. 6B are explanatory views of a second operation of the control unit of FIG. 3.

FIG. 7 is a block diagram showing another example of the control unit.

FIG. 8A to FIG. 8D are memory maps of memories used in FIG. 7.

FIG. 9A and FIG. 9B are explanatory views of a first operation of the control unit of FIG. 7.

FIG. 10A and FIG. 10B are explanatory views of a second operation of the control unit of FIG. 7.

FIG. 11A and FIG. 11B are explanatory views of a third operation of the control unit of FIG. 7.

FIG. 12A and FIG. 12B are explanatory views of a fourth operation of the control unit of FIG. 7.

### DETAILED DESCRIPTION

Throughout this description, the embodiments and examples shown should be considered as exemplars, rather than limitations on the apparatus of the present invention.

Hereinafter, embodiments of an electronic equipment according to the invention will be described in detail with reference to the drawings. In the drawings, the same parts are denoted by the same reference numerals.

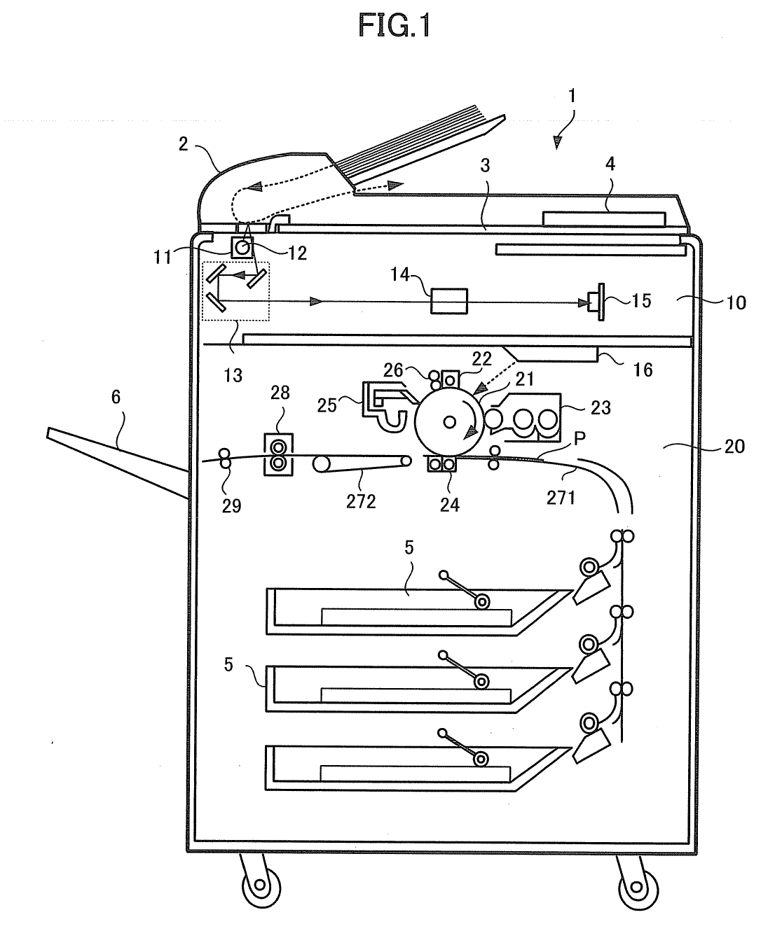

FIG. 1 is a view showing the configuration of an image forming apparatus as an embodiment of the electronic equipment. In the following description, an MFP (multi-function peripheral), which is a multi-function machine, is employed as an example of the image forming apparatus.

In FIG. 1, an automatic document feeder (ADF) 2, a transparent document table 3, and an operation panel 4 are provided on top of an image forming apparatus (MFP) 1. The MFP 1 also has a scanner unit 10 and a printer unit 20. The scanner unit 10 is for scanning an image of an original. The printer unit 20 is for forming an image on a sheet in accordance with scanned data.

The scanner unit 10 has a carriage 11, an exposure lamp 12, a reflection mirror 13, a lens 14, a CCD (charge coupled device) 15, and a laser unit 16. In the scanner unit 10, in order to scan an original carried by the ADF 2 or a document set on the document table 3, light from the exposure lamp 12 provided in the carriage 11 is cast onto the document from below the document table 3, and the reflected light from the document is taken into the CCD 15 via the reflection mirror 13 and the lens 14.

Image information taken in the CCD 15 is outputted as an analog signal. The analog signal is converted to a digital signal, to which image processing is then carried out, thereby producing image data. The image data is supplied to the laser unit 16. In accordance with the image data, a laser beam is generated from the laser unit 16.

The printer unit 20 has a photoconductive unit 21. Around the photoconductive unit 21, a charger device 22, a developing device 23, a transfer device 24, a cleaner 25 and a neutralizing lamp 26 are provided along the direction of rotation of the photoconductive unit 21. The laser beam from the laser unit 16 is cast onto the photoconductive unit 21. An electrostatic latent image corresponding to the image information of the document is formed and held on the outer circumferential surface of the photoconductive unit 21.

As image formation starts, the charger device 22 performs discharge at a predetermined discharge position and thus charges the outer circumferential surface of the rotating photoconductive unit 21 uniformly in the axial direction with predetermined electric charges. Then, a laser beam is cast onto the photoconductive unit 21 from the laser unit 16 and an electrostatic latent image is formed and held on the outer circumferential surface of the photoconductive unit 21.

A developer (for example, toner) is provided from the developing device 23 to the outer circumferential surface of the photoconductive unit 21, and the electrostatic latent image is converted to a toner image and thus developed. The toner image formed on the outer circumferential surface of the photoconductive unit 21 is electrostatically transferred to a sheet P by the transfer device 24. The sheet P is carried from a paper feeder device 5 (which will be described later) through a carrying path 271. The toner that is not transferred and is remaining on the photoconductive unit 21 is removed by the cleaner 25 situated downstream in the direction of rotation of the photoconductive unit 21. After that, the residual charges on the outer circumferential surface of the photoconductive unit 21 are eliminated by the neutralizing lamp 26.

The configuration of the printer unit 20 is not limited to the example shown in FIG. 1 and may employ other systems such as a system using an intermediate transfer belt. The MFP 1 can also process print data inputted from a PC (Personal Computer) or the like and output the processed data to the printer unit 20, which then prints out the data.

Meanwhile, in order to supply sheets to the printer unit 20, plural paper feeder devices 5 are provided below the printer unit 20. Sheets from the paper feeder device 5 are carried to the transfer device 24 through the carrying path 271.

The sheet P to which the toner image is transferred by the printer unit 20 is carried to a fixing device 28 via a carrying belt 272. In the fixing device 28, a heating roller and a pressurizing roller are provided facing each other. As the sheet P is passed between the heating roller and the pressurizing roller, the toner image transferred onto the sheet P is fixed to the sheet P. The sheet P on which image formation is completed by fixing the toner image is discharged to a tray 6 by paper discharge rollers 29.

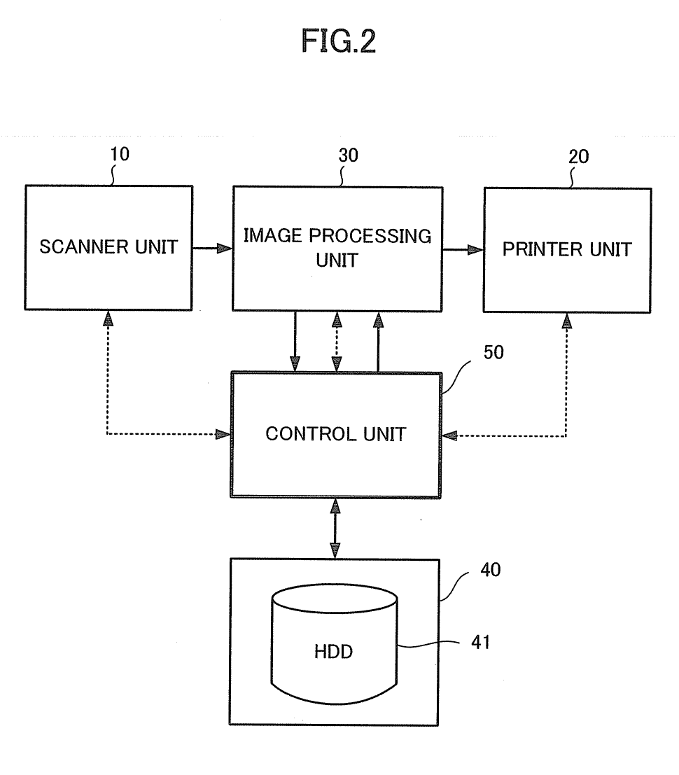

FIG. 2 is a block diagram showing the circuit configuration of the image forming apparatus 1 according to the embodiment. As shown in FIG. 2, the image forming apparatus 1 has the scanner unit 10 that scans the document, an image processing unit 30 that processes the scanned document image, the printer unit 20 that prints the image-processed data to a sheet, and a storage unit 40 that stores the processed image data. The storage unit 40 includes an HDD 41 or another storage medium. The image forming apparatus 1 also has a control unit 50 that controls the scanner unit 10, the printer unit 20, the image processing unit 30 and the storage unit 40.

In the embodiment shown in FIG. 2, for example, print data inputted from a PC (Personal Computer) or the like is usually in the PDL (Page Description Language) format and therefore needs to be converted to bitmap-format data in order to be actually printed.

The control unit 50 has a RIP (Raster Image Processor) function and converts PDL-format data to bitmap-format data by using its RIP. The data converted by the RIP is temporarily saved in the HDD 41. The data saved in the HDD 41 is outputted from the control unit 50 to the printer unit 20 via the image processing unit 30 and is then print-processed.

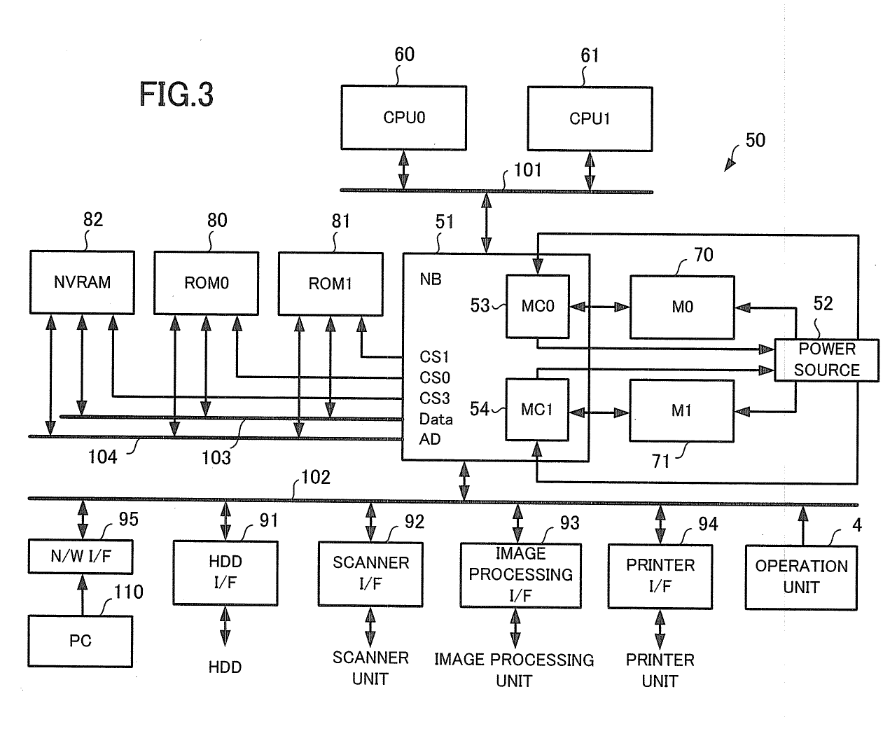

FIG. 3 is a block diagram showing an embodiment of the control unit 50.

In FIG. 3, the control unit 50 has a north bridge (NB) 51 that functions as a controller, CPUs 60 and 61 (CPU0,CPU1) , memories 70 and 71 (M0, M1), a power source 52 to drive the memories, ROMs 80 and 81 (ROM0, ROM1), a non-volatile memory (NVRAM) 82, and various interfaces 91, 92, 93, 94 and 95. The control unit 50 also has bus lines 101 and 102 for communicating data between devices.

The CPUs 60 and 61 are connected to the bus line 101. One of the CPUs 60 and 61 operates as a master and the other operates as a slave. The memories 70 and 71 can save programs, data acquired by processing document images, RIP data and so on.

A program to execute non-RIP first processing is saved in the ROM 80. A RIP program is saved in the ROM 81. The NVRAM 83 stores the master state and slave state of the CPUs 60 and 61 and also stores the state of use of programs in the memories 70 and 71 (RIP program or non-RIP program). To carry out RIP processing, the RIP program is loaded from the ROM 81 to a RIP memory.

The interfaces (I/F) 91 to 95 are connected to the bus line 102 and transfer various data via the bus line 102. The HDD interface 91 transfers data to and from the storage unit 40 (HDD 41). The scanner interface 92 transfers control data to and from the scanner unit 10. The image processing interface 93 transfers image data and control data to and from the image processing unit 30. The printer interface 94 transfers data to and from the printer unit 20.

The network interface 95 is for receiving data from an external device, for example, a PC (Personal Computer) 110, connected to the MFP 1 via a network. Also an operation unit 4 is connected to the bus line 102. Various instructions from an operator are inputted via the operation unit 4.

The north bridge 51 (controller) mediates and controls input and output of data between the CPUs 60 and 61, the memories 70 and 71, and the devices connected to the bus line 102, and so on. In the north bridge 51, memory controllers 53 and 54 (MC0, MC1) are provided that control the memories 70 and 71. The memory controllers 53 and 54 control the power source 52 to turn on and off power supplied to the memories 70 and 71.

Moreover, the north bridge 51 is connected to the ROMs 80 and 81 and the NVRAM 82 via a data line 103 and an address line 104 and also supplies chip select signals (CS0, CS1, CS3) to the ROMs 80 and 81 and the NVRAM 82.

In FIG. 3, one of the memories 70 and 71 is used as a standard memory for non-RIP processing, and the other is used as an extended memory for RIP processing. However, if one memory is exclusively used as a standard memory and the other memory is exclusively used as an extended memory, the frequency of use differs significantly between the memories 70 and 71.

Thus, the state of use of the memories 70 and 71 is sequentially switched every time the OS (Operating System) starts.

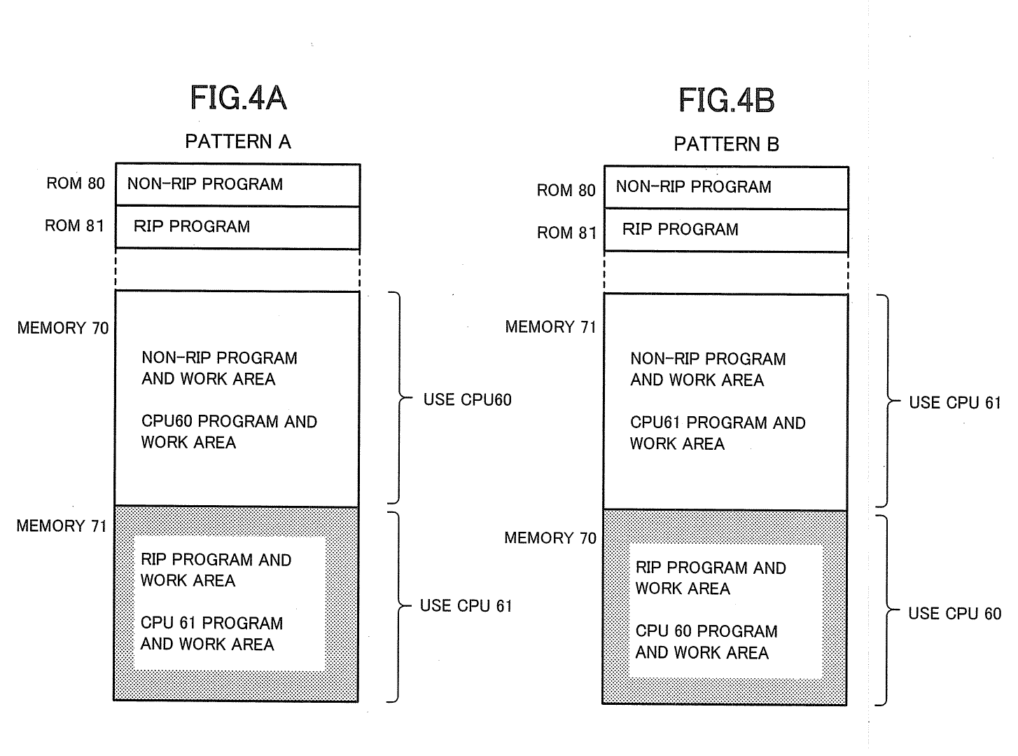

FIG. 4A and FIG. 4B show memory maps of the ROMs 80 and 81 and the memories 70 and 71 (M0, M1). In this embodiment, when the memory map of FIG. 4A is referred to as a pattern A and the memory map of FIG. 4B is referred to as a pattern B, the pattern A and the pattern B are sequentially switched every time the OS is started.

Specifically, in FIG. 4A (pattern A), the program to execute ordinary non-RIP processing is saved in the ROM 80 and the program to execute RIP processing is saved in the ROM 81.

When the OS (Operating System) is started, one CPU 60 serves as a master and the other CPU 61 serves as a slave. In the memories 70 and 71, data processing is carried out using the CPUs 60 and 61, respectively.

The memory 70 is used as an operation area for performing non-RIP first processing. The memory 70 has a program area and a work area for non-RIP processing and also has a program area and a work area for the CPU 60. The memory 71 is used as an operation area for second processing, that is, RIP processing. The memory 71 has a program area and a work area for RIP processing and also has a program area and a work area for the CPU 61.

Thus, when the OS is started and the non-RIP first processing is carried out, the memory 70 operates under the control of the CPU 60 in accordance with the program saved in the ROM 80. The CPU 61 for RIP processing is inactive (sleep) and the memory 71 for RIP processing is inactive as well (power off). The CPU that shifts into the sleep mode stops execution of commands and supply of clocks. As a preset interrupt signal is inputted from outside, this CPU restores its normal state.

When RIP processing (second processing) is carried out, the inactive state of the CPU 61 and the memory 71 is canceled. The CPU 61 operates and the power of the memory 71 turns on. Then, the memory 71 operates under the control of the CPU 61 in accordance with the program saved in the ROM 81. RIP processing is thus executed. In this manner, when carrying out RIP processing, data conversion is carried out by using the extended memory (memory 71).

Meanwhile, when the OS is rebooted after it is stopped, the control unit 50 operates in accordance with the pattern B of FIG. 4B. Specifically, in FIG. 4B (pattern B), the program to execute non-RIP processing is saved in the ROM 80 and the program to execute RIP processing is saved in the ROM 81. When the OS is rebooted, the CPU 61 serves as a master and the CPU 60 serves as a slave.

The memory 71 is used as an operation area for performing non-RIP processing. The memory 71 has a program area and a work area for non-RIP processing and also has a program area and a work area for the CPU 61. The memory 70 is used as an operation area for RIP processing. The memory 70 has a program area and a work area for RIP processing and also has a program area and a work area for the CPU 60.

Thus, when the OS is rebooted and non-RIP processing is carried out, the memory 71 operates under the control of the CPU 61. The CPU 60 for RIP processing is inactive (sleep) and the memory 70 for RIP processing is inactive as well (power off). When RIP processing is carried out, the inactive state of the CPU 60 and the memory 70 is canceled. The CPU 60 operates and the power of the memory 70 turns on. Then, the memory 70 operates under the control of the CPU 60. RIP processing is thus executed. In this manner, when carrying out RIP processing, data conversion is carried out by using the memory 70.

Since the roles of the CPUs 60 and 61 and the memories 70 and 71 are switched in this way every time the OS is started, the north bridge 51. (controller) carries out the following control.

Specifically, the north bridge 51 reverses the master-slave relation between the CPUs 60 and 61 every time the OS is started. As the master and slave are switched, the program to be used is switched as well every time the OS starts. Thus, the master CPU is used for non-RIP processing and the slave CPU is used for RIP processing.

The north bridge 51 also rewrites base addresses set to the memory controllers 53 and 54 every time the OS is started. Therefore, in certain startup timing, one of the memories 70 and 71 is used for non-RIP processing and the other memory is used for RIP processing. The next time the OS is started, the one memory is used for RIP processing and the other memory is used for non-RIP processing.

The north bridge 51 controls the (slave) CPU for RIP processing and causes the slave CPU to be inactive (sleep) while non-RIP processing is carried out. When carrying out RIP processing, the north bridge 51 causes the slave CPU to recover from inactive state to carry out RIP processing.

The memory controllers 53 and 54 cause the memory for RIP processing to be inactive (power off) while non-RIP processing is carried out. When carrying out RIP processing, the memory controllers 53 and 54 cause the memory for RIP processing to recover from inactive state.

Immediately after recovering from inactive state (power off state), the memory for RIP processing (memory 70 or memory 71) has no program. Therefore, to carry out RIP processing, the RIP program is loaded from the ROM 81 to the RIP memory to operate.

Information about the master and slave state of the CPUs 60 and 61, and information about the state of use of the programs in the memories 70 and 71 (RIP program or non-RIP program) are stored in the NVRAM 82.

For example, if the master and slave state of the CPUs 60 and 61 and the state of use of the programs in the memories 70 and 71 are written in the reversed state to the NVRAM 82 when the OS ends, next time the OS is started, by reading information in NVRAM 82, the state of use of the CPUs 60 and 61 and the memories 70 and 71 can be reversed the next time the OS is started. In this manner, the roles of the CPUs 60 and 61 and the memories 70 and 71 are alternately switched every time the OS is started.

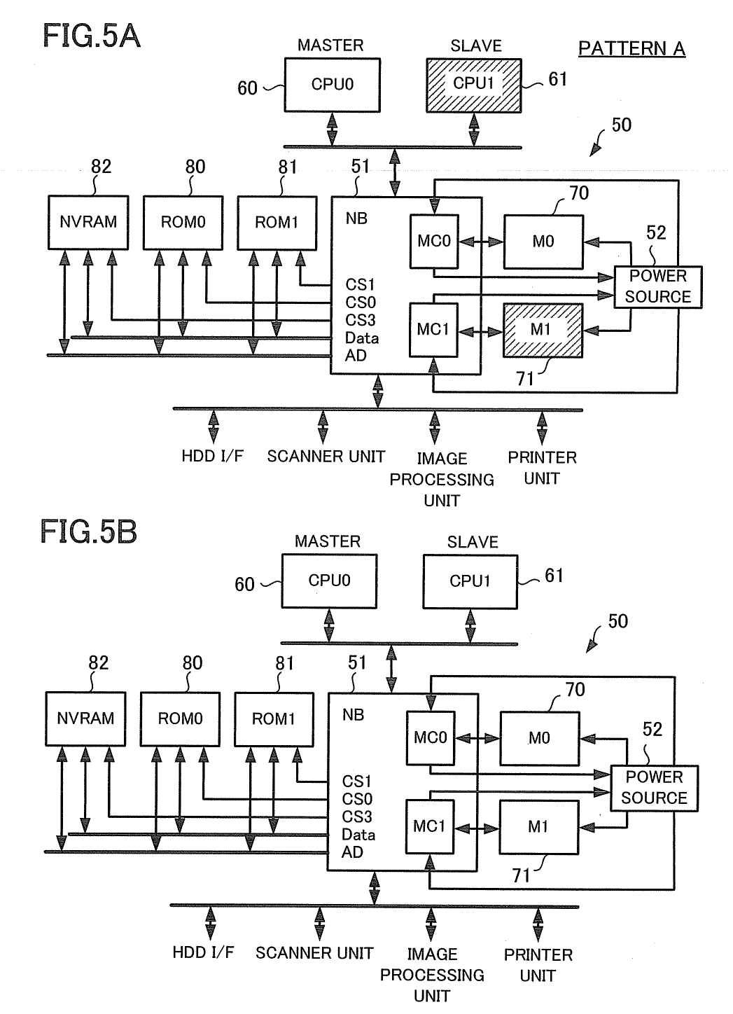

FIG. 5A and FIG. 5B are explanatory views showing operations of the control unit 50 with the memory map of pattern A. FIG. 5A shows the ordinary operation to carry out non-RIP processing. FIG. 5B shows the operation when carrying out RIP processing. The shading of the CPU and the memory in FIG. 5A indicates that these are inactive.

In FIG. 5A, the CPU 61 for RIP (slave) is inactive and in sleep state. Also the memory 71 for RIP is inactive (power off). On the other hand, if RIP processing is carried out, the CPU 61 for RIP (slave) recovers from inactive state and also the memory 71 recovers from inactive state, thus enabling the RIP operation, as shown in FIG. 5B.

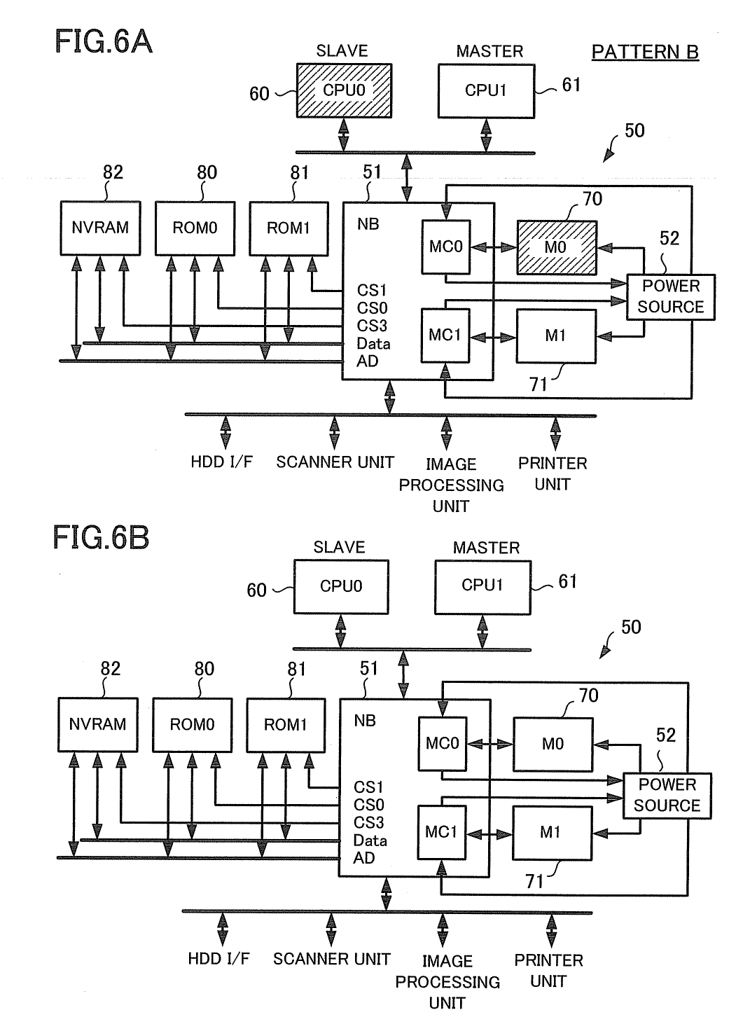

FIG. 6A and FIG. 6B are explanatory views with the memory map of pattern B.

FIG. 6A shows the ordinary operation to carry out non-RIP processing. FIG. 6B shows the operation when carrying out RIP processing. The shading of the CPU and the memory in FIG. 6A indicates that these are inactive.

In FIG. 6A, the CPU 60 serves as a slave and the CPU 61 serves as a master. The CPU 60 for RIP (slave) is inactive and in sleep state. Also the memory 70 for RIP is inactive (power off) . On the other hand, if RIP processing is carried out, the CPU 60 for RIP (slave) recovers from inactive state and also the memory 70 recovers from inactive state, thus enabling the RIP operation, as shown in FIG. 6B.

In the above description, the power source 52 is controlled to turn off the memory 70 or the memory 71 so that the memory used for the RIP operation is made inactive when the ordinary operation is carried out. Alternatively, the memory 70 or 71 may be shifted to the power-down mode or self-refresh mode and thus made inactive.

In the memory power-down mode, power consumption can be reduced since writing and reading are not carried out. The memory self-refresh mode refers to a mode in which refreshing is automatically carried out to hold data without input of a clock or command from outside. As the memory shifts to the self-refresh mode, the power consumption of the memory can be reduced to approximately 1/10 of the power consumption in the ordinary operation.

To shift the mode of the memory to the power-down mode or self-refresh mode, a technique such as controlling a signal of a predetermined terminal provided in the memory, for example, a clock-enable terminal, to LOW level may be employed.

When RIP processing is carried out, the two CPUs 60 and 61 and the memories 70 and 71 may be simultaneously used for RIP. This can realize enhancement of the RIP processing capability and reduction in processing time.

Thus, according to this embodiment, when the first processing is carried out, the CPU and memory used for the second processing (RIP) can be made inactive to reduce power consumption. Moreover, as the state of use of the CPUs and memories is sequentially (alternately) switched every time the OS is started, the time of use of the CPUs and memories can be averaged. Therefore, there is little variance in the time of use of the CPUs and memories and a longer life can be realized for the CPUs and memories. This enables elongation of the life of the entire system.

In the above description, the roles of the CPUs 60 and 61 and the memories 70 and 71 are alternately switched every time the OS is started. However, the roles of the CPUs 60 and 61 and the memories 70 and 71 may be alternately switched every time the power source of the MFP 1 is turned on. The OS starts when the power source is turned on. The OS stops when the power source is shut down. Therefore, turning on or off of the power source means the start (reboot) or stop of the OS.

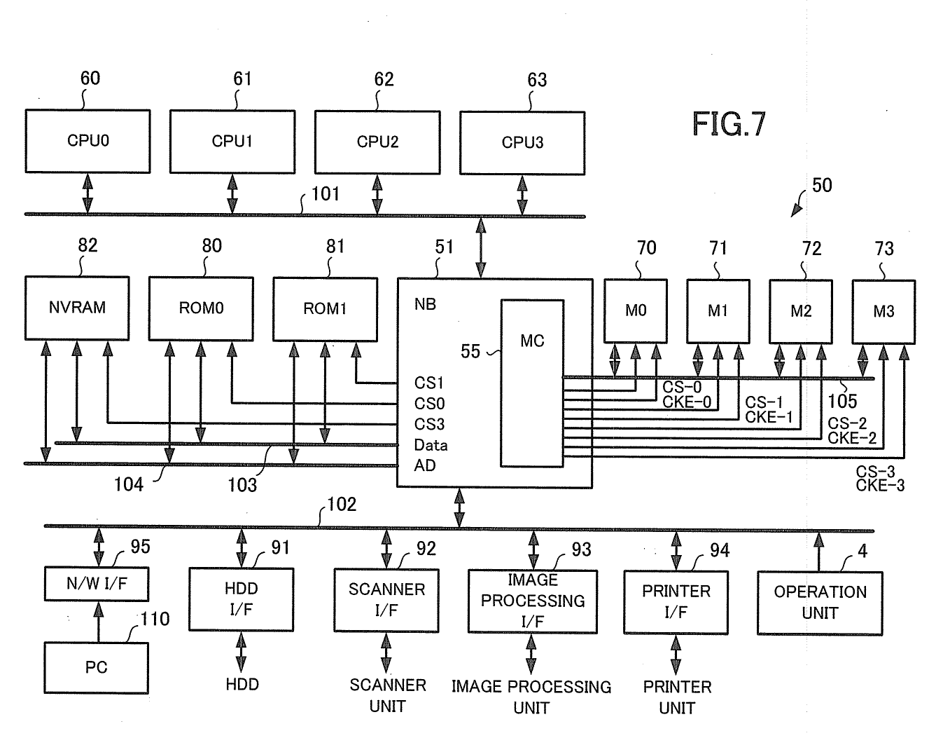

FIG. 7 is a block diagram showing another example of the control unit 50.

In FIG. 7, the control unit 50 has a north bridge (NB) 51, CPUs 60, 61, 62 and 63 (CPU0, CPU1, CPU2, CPU3), memories 70, 71, 72 and 73 (M0, M1, M2, M3), ROMs 80 and 81 (ROM0, ROM1), a NVRAM 82, and various interfaces 91, 92, 93, 94 and 95. The control unit 50 also has bus lines 101 and 102 for communicating data between devices.

The CPUs 60 to 63 are connected to the bus line 101. One of the CPUs (for example, the CPU 60) operates as a master and the other CPUs (for example, the CPUs 61, 62 and 63) operate as slaves. The memories 70 to 73 save programs, data acquired by processing original images, and RIP data. The ROMs 80 and 81 save various programs (RIP program or programs to execute non-RIP processing and so on). The NVRAM 83 stores the master state and slave state of the CPUs 60 to 63 and also stores the state of use of programs in the memories 70 to 73 (RIP program or non-RIP program).

The interfaces (I/F) 91 to 95 are connected to the bus line 102. These interfaces are the HDD interface 91, the scanner interface 92, the image processing interface 93, the printer interface 94, and the network interface 95, as in FIG. 3. Moreover, the operation unit 4 is connected to the bus line 102.

The north bridge 51 functions as a controller and mediates data transfer between devices. A memory controller 55 that controls the memories 70 to 73 is provided in the north bridge 51. The memory controller 55 controls the operation state of the memories 70 to 73. To this end, the memory controller 55 supplies chip select signals (CS-0 to CS-3) and clock-enable signals (CKE-0 to CKE-3) to the memories 70 to 73.

The memory controller 55 and the memories 70 to 73 are connected by a bus line 105. Data and various signals such as row address (RAS), column address (CAS) and write enable (WE) are sent to the memories 70 to 73 via the bus line 105. The memory controller 55 controls the chip select signals (CS-0 to CS-3) and clock-enable signals (CKE-0 to CKE-3) to the memories 70 to 73, and thereby switches each of the memories 70 to 73 to inactive state (power-down mode) and ordinary mode.

Moreover, the north bridge 51 is connected to the ROMs 80 and 81 and the NVRAM 82 via a data line 103 and an address line 104 and also supplies chip select signals (CS0, CS1, CS3) to the ROMs 80 and 81 and the NVRAM 82.

In the control unit 50 of FIG. 7, the number of CPUs and memories is increased, compared to FIG. 3, and the four CPUs 60 to 63 and the four memories 70 to 73 are provided. In the ordinary operation to carry out non-RIP processing, one CPU (for example, the CPU 60) serves as a master and the other CPUs (for example, the CPUs 61, 62 and 63) serve as slaves. The relation between the master and slave CPUs is sequentially switched every time the OS is started, and the program used after the startup of the OS is switched.

As for the memories 70 to 73, too, a memory for RIP and memories for executing non-RIP processing are sequentially switched as the base address set to the memory controller 55 are rewritten every time the OS is started (or every time the OS ends). The memory for RIP is inactive (power-down mode) when RIP processing is not carried out.

There is no program in the memory for RIP immediately after the memory for RIP is recovered from inactive state to operating state in order to carry out RIP processing. Therefore, the RIP program is loaded from the ROM 81 to the memory for RIP when the RIP operation is carried out.

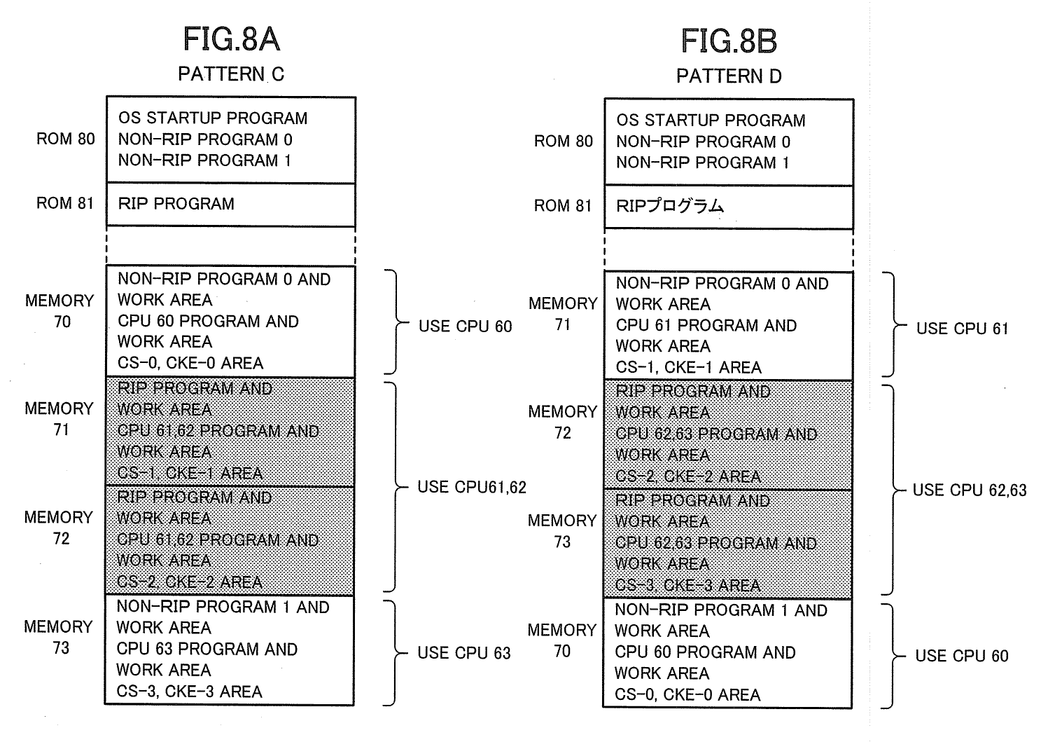

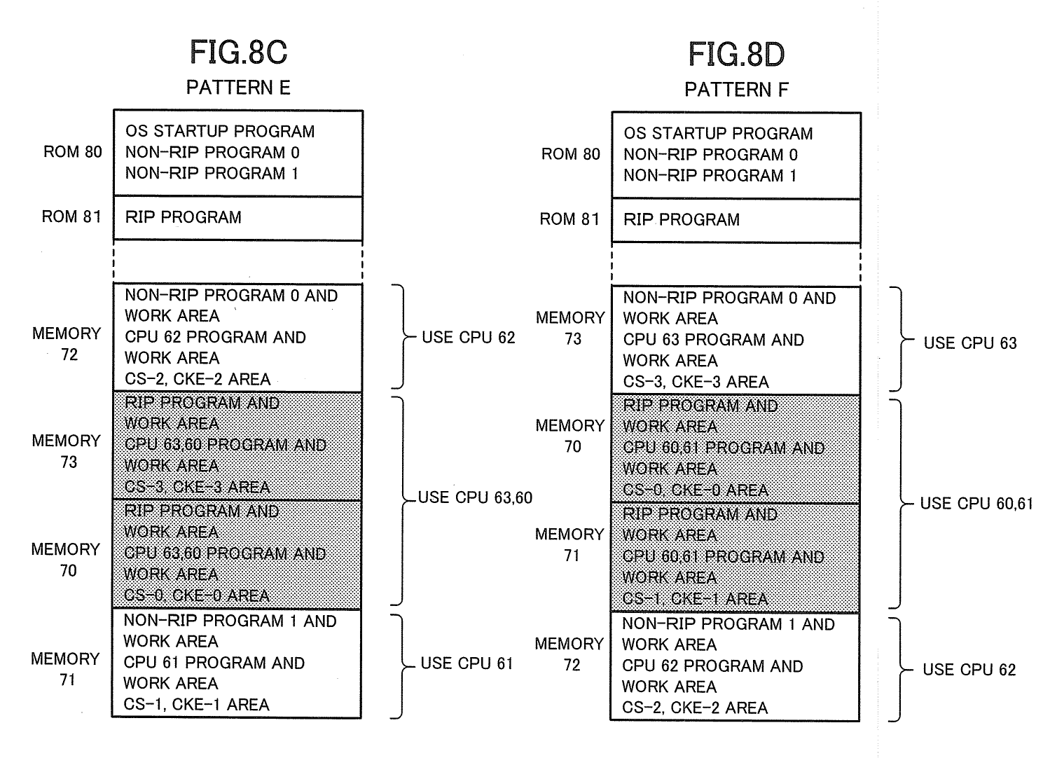

FIG. 8A to FIG. 8D show memory maps of the ROMs 80 and 81 and the memories 70 to 73. The memory maps shown in FIG. 8A to FIG. 8D are patterns C, D, E and F, respectively. This embodiment is characterized in that the patterns C, D, E and F are sequentially switched every time the OS is started.

That is, in FIG. 8A (pattern C), the OS start program, and a program 0 and a program 1 to execute non-RIP processing are saved in the ROM 80. A program to execute RIP processing is saved in the ROM 81.

When the OS is started, the first CPU 60 serves as a master and the other CPUs 61 to 63 serve as slaves. In the memories 70 to 73, data are processed by using the CPUs 60 to 63, respectively. The memory 70 is used as a non-RIP operation area. The memory 70 has a non-RIP program 0 area and work area and also has a program area and work area for the CPU 60. The memory 70 also has an area for the chip select signal CS-0 and the clock-enable signal CKE-0.

Each of the memories 71 and 72 is used as a RIP operation area. The memories 71 and 72 have a RIP program area and work area and also have a program area and work area for the CPUs 61 and 62, respectively. The memory 71 also has an area for the chip select signal CS-1 and the clock-enable signal CKE-1. The memory 72 has an area for the chip select signal CS-2 and the clock-enable signal CKE-2.

The memory 73 is used as a non-RIP operation area. The memory 73 has a non-RIP program 1 area and work area and also has a program area and work area for the CPU 63. The memory 73 also has an area for the chip select signal CS-3 and the clock-enable signal CKE-3.

Therefore, when starting the OS and carrying out non-RIP processing, the memory 70 operates under the control of the CPU 60 and non-RIP processing is executed. The CPUs 61 and 62 for RIP are inactive (sleep) and the memories 71 and 72 for RIP are inactive as well. When performing RIP processing, the inactive state of the CPUs 61 and 62 and the memories 71 and 72 is canceled. The memories 71 and 72 operate under the control of the CPUs 61 and 62 to execute RIP processing.

In this manner, if RIP processing is carried out, the two CPUs and the two memories are used to convert data, thereby enabling enhancement of processing capability and reduction in processing time.

If another processing is carried out simultaneously with RIP processing, the memory 73 operates under the control of the CPU 63. For example, processing to send data stored in the HDD 41 to the PC 110 via the network interface 95 can be carried out simultaneously during printing. In short, though another job cannot be executed because of the load during the RIP operation, the additional CPU 63 and memory 73 enable execution of another job.

The memory maps of FIG. 8B to FIG. 8D will be briefly described. The CPUs and memories for executing non-RIP processing are sequentially switched and the CPU and memory for RIP are sequentially switched as well. The control unit 50 operates in accordance with FIG. 8B (pattern D) to FIG. 8D (pattern F) every time the OS is stopped and then rebooted.

That is, in FIG. 8B (pattern D), the CPU 61 and the memory 71, and the CPU 60 and the memory 70 operate when executing non-RIP processing. The CPUs 62 and 63 and the memories 72 and 73 operate when executing RIP processing.

In FIG. 8C (pattern E), the CPU 62 and the memory 72, and the CPU 61 and the memory 71 operate when executing non-RIP processing. The CPUs 63 and 60 and the memories 73 and 70 operate when executing RIP processing.

In FIG. 8D (pattern F), the CPU 63 and the memory 73, and the CPU 62 and the memory 72 operate when executing non-RIP processing. The CPUs 60 and 61 and the memories 70 and 71 operate when executing RIP processing.

In this manner, in the patterns D to F, two extended memories are used to convert data if RIP processing is carried out.

The north bridge 51 sequentially switches the operation of the CPUs 60 to 63 and the memories 70 to 73 every time the OS is started. One of the plural CPUs is caused to serve as a master and the remaining CPUs are caused to serve as slaves.

The north bridge 51 also rewrites the base address set to the memory controller 55 every time the OS is started. Therefore, the memories 70 to 73 are used for non-RIP processing in certain startup timing and are used for RIP processing in another startup timing.

The north bridge 51 also controls the CPU for RIP so that the CPU for RIP is made inactive (sleep) while non-RIP processing is carried out, and so that the CPU for RIP recovers from inactive state when carrying out RIP processing. Meanwhile, the memory controller 55 makes the memory for RIP inactive while non-RIP processing is carried out, and causes the memory for RIP to recover from inactive state when carrying out RIP processing.

Information about the master and slave state of the CPUs 60 to 63, and information about the state of use of the programs in the memories 70 to 73 (RIP program or non-RIP program) are stored in the NVRAM 82.

In this manner, the roles of the CPUs 60 to 63 and the memories 70 to 73 are sequentially switched every time the OS starts.

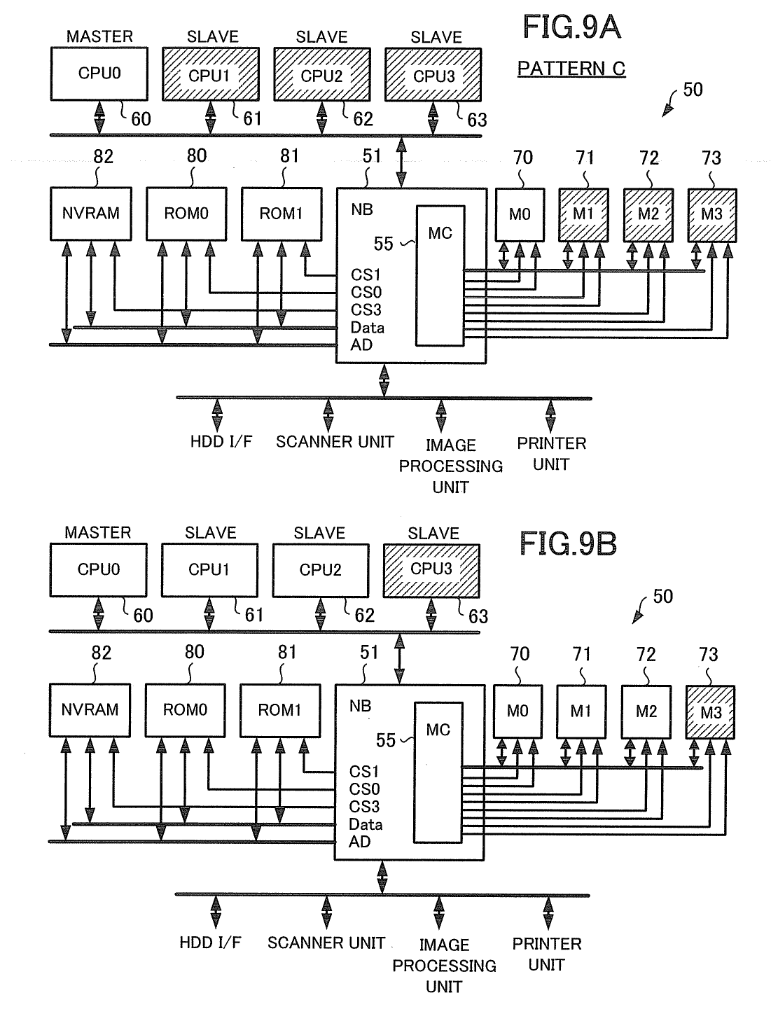

FIG. 9A and FIG. 9B are explanatory views showing operations with the memory map of pattern C.

FIG. 9A shows the ordinary operation to carry out non-RIP processing. FIG. 9B shows the operation when carrying out RIP processing. The shading of the CPU and the memory in FIG. 9A and FIG. 9B indicates that these CPU and memory are inactive.

In the ordinary operation of FIG. 9A, the CPU 60 (master) and the memory 70 are active. The CPUs 61 and 62 for RIP (slaves) are inactive and in sleep state. The memories 71 and 72 for RIP are inactive as well. The CPU 63 and the memory 73 are also inactive.

On the other hand, if RIP processing is carried out, the CPUs 61 and 62 for RIP (slave) recover from inactive state and also the memories 71 and 72 recover from inactive state, thus enabling the RIP operation, as shown in FIG. 9B. The CPU 63 and the memory 73 restore to the operating state when executing non-RIP interrupt processing.

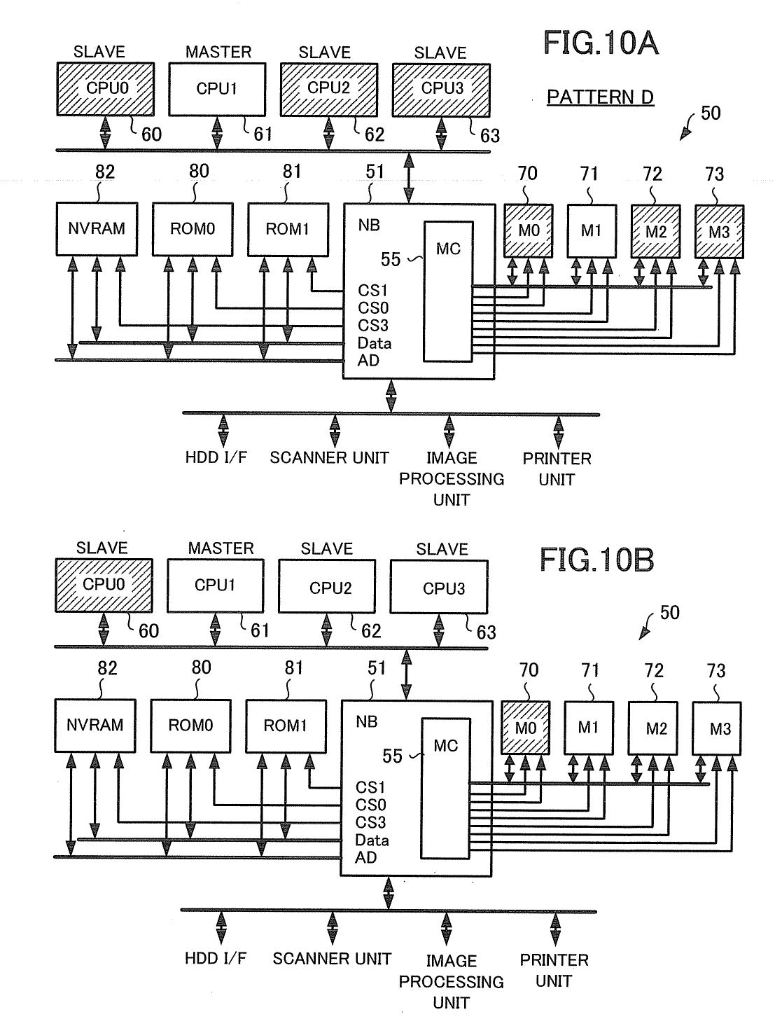

FIG. 10A and FIG. 10B are explanatory views showing operations with the memory map of pattern D. FIG. 10A shows the ordinary operation to carry out non-RIP processing. FIG. 10B shows the operation when carrying out RIP processing. The shading of the CPU and the memory in FIG. 10A and FIG. 10B indicates that these CPU and memory are inactive.

In FIG. 10A, the CPU 61 (master) and the memory 71 carry out non-RIP processing. The CPUs 62 and 63 (slaves) and the memories 72 and 73 operate when carrying out RIP processing. Also, the CPU 60 (slave) and the memory 70 carry out non-RIP processing (interrupt processing).

In the ordinary operation of FIG. 10A, the CPU 61 (master) and the memory 71 are active. The CPUs 62 and 63 for RIP (slaves) are inactive. The memories 72 and 73 for RIP are inactive as well. The CPU 60 and the memory 70 are also inactive.

On the other hand, if RIP processing is carried out, the CPUs 62 and 63 for RIP (slave) recover from inactive state and also the memories 72 and 73 recover from inactive state, thus enabling the RIP operation, as shown in FIG. 10B. The CPU 60 and the memory 70 restore to the operating state when executing non-RIP interrupt processing.

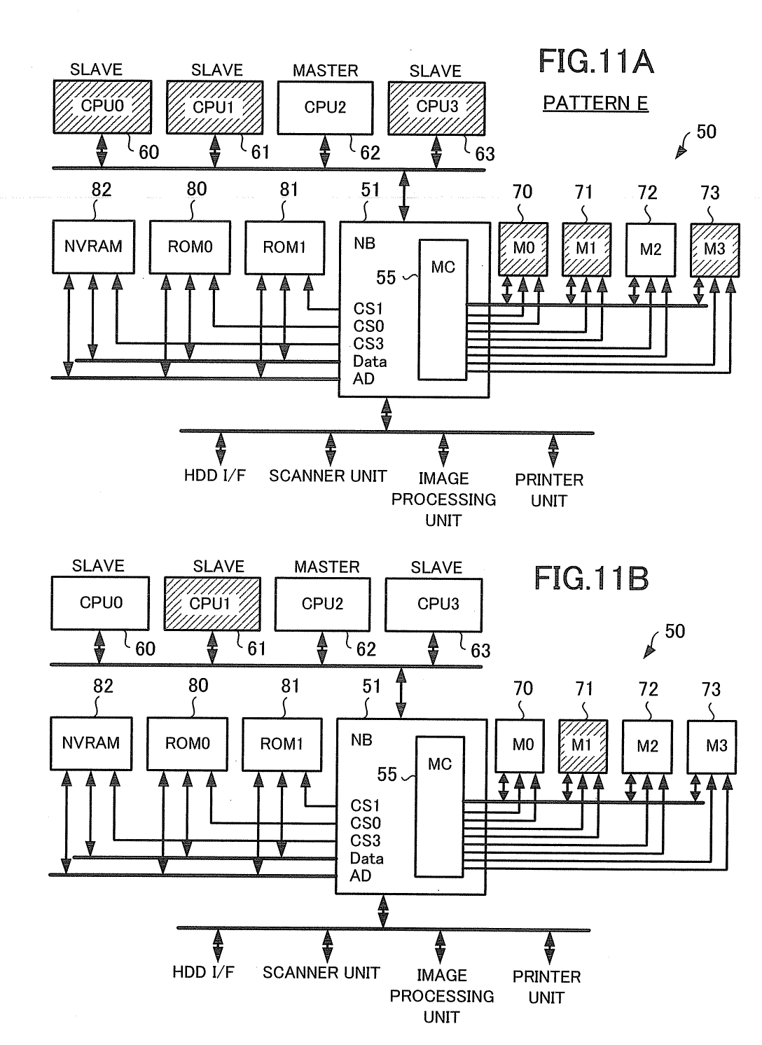

FIG. 11A and FIG. 11B are explanatory views showing operations with the memory map of pattern E. FIG. 11A shows the ordinary operation to carry out non-RIP processing. FIG. 11B shows the operation when carrying out RIP processing.

In the pattern E, the CPU 62 (master) and the memory 72 carry out non-RIP processing. The CPUs 63 and 60 (slaves) and the memories 73 and 70 operate when carrying out RIP processing. Also, the CPU 61 (slave) and the memory 71 carry out non-RIP processing (interrupt processing).

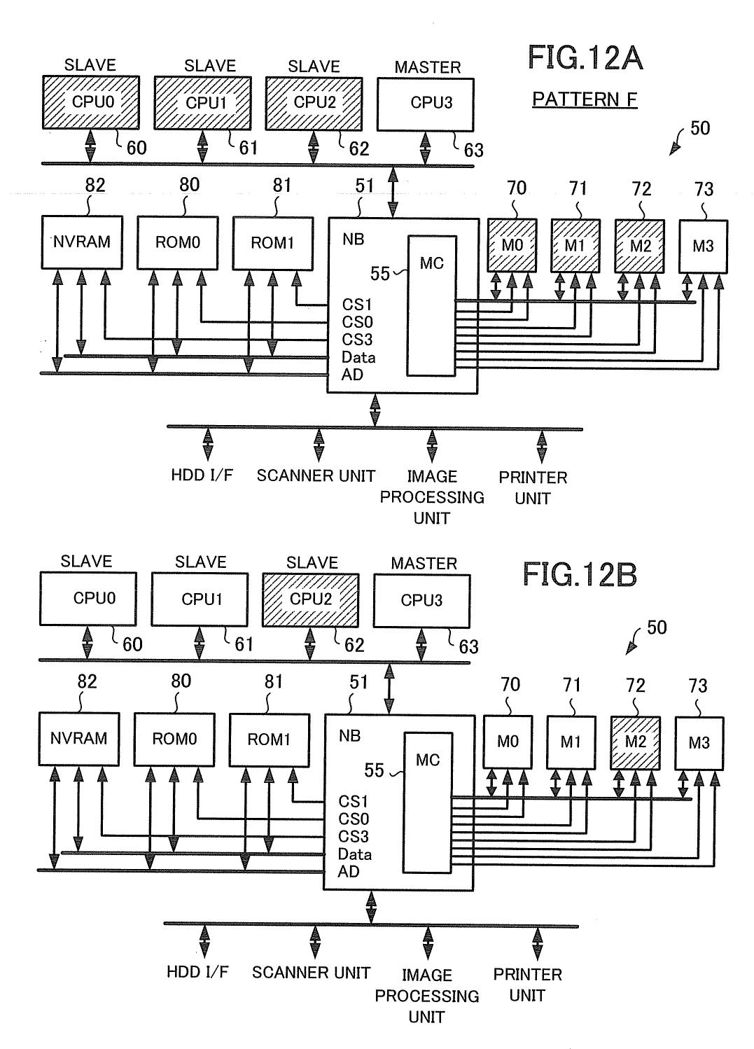

FIG. 12A and FIG. 12B are explanatory views showing operations with the memory map of pattern F. FIG. 12A shows the ordinary operation to carry out non-RIP processing. FIG. 12B shows the operation when carrying out RIP processing.

In the pattern F, the CPU 63 (master) and the memory 73 carry out non-RIP processing. The CPUs 60 and 61 (slaves) and the memories 70 and 71 operate when carrying out RIP processing. Also, the CPU 62 (slave) and the memory 72 carry out non-RIP processing (interrupt processing).

Thus, according to the example of FIG. 7, the CPUs and memories which operate respectively for the ordinary processing and for RIP processing are sequentially switched every time the OS is started. When carrying out the ordinary operation, the CPU and memory used for the RIP operation can be made inactive to reduce power consumption.

Moreover, as the state of use of the CPUs and memories is sequentially switched every time the OS is started, the time of use of the CPUs and memories can be averaged. Therefore, there is little variance in the time of use of the CPUs and memories and a longer life can be realized for the CPUs and memories. This enables elongation of the life of the entire system.

In the above examples, two or four CPUs and memories each are used. However, plural CPUs and memories (three, four or more) can be used.

Moreover, while the RIP function of the image forming apparatus is described in the above explanation, a circuit configuration similar to FIG. 3 or FIG. 7 can be applied to other electronic equipments having a first processing mode using a standard memory and a second processing mode using an extended memory.

Although exemplary embodiments are shown and described, it will be apparent to those having ordinary skill in the art that a number of changes, modifications, or alterations as described herein may be made, none of which depart from the spirit of the invention. All such changes, modifications, and alterations should therefore be seen as within the scope.

What is claimed is:

1. An electronic equipment comprising:
plural CPUs, wherein when a first CPU of the plural CPUs is a master, the other CPU is a slave;
plural memories provided corresponding to the plural CPUs, the plural memories including a memory that operates and is used for first processing when the master CPU operates, and a memory that operates and is used for second processing when the slave CPU operates; and
a controller that sequentially switches the CPU to serve as a master of the plural CPUs, then causes the remaining CPU to serve as a slave and sequentially switches the memories used for the first processing and the second processing, every time an OS (Operating System) starts.

2. The electronic equipment according to claim 1, wherein when executing the first processing, the controller makes the slave CPU inactive and controls the other memory than the memory used for the first processing of the plural memories, to be inactive.

3. The electronic equipment according to claim 2, wherein when executing the first processing, the controller causes the slave CPU to be in sleep state and controls the other memory than the memory used for the first processing of the plural memories, to be in a power-off or power-down mode.

4. The electronic equipment according to claim 1, wherein the controller sequentially switches the CPU to serve as the master every time power is turned on.

5. The electronic equipment according to claim 1, further comprising a non-volatile memory that stores master and slave states of the plural CPUs and state of use of the plural memories every time the OS (Operating System) is stopped,
wherein the controller sequentially switches the CPU to serve as the master every time the OS is started, in accordance with information stored in the non-volatile memory.

6. The electronic equipment according to claim 1, further comprising:
a first ROM in which a first program to execute the first processing is saved; and
a second ROM in which a second program to execute the second processing is saved;
wherein the controller loads the programs saved in the first and second ROMs to the plural memories when executing the first processing and when executing the second processing.

7. The electronic equipment according to claim 1, wherein the plural CPUs include first and second CPUs,
the plural memories include first and second memories provided corresponding to the first and second CPUs, and
the controller alternately switches a master-slave relation between the first and second CPUs every time the OS starts, and the controller switches the first and second memories in the use for the first processing or the second processing.

8. An image forming apparatus having a RIP (Raster Image Processor) function, comprising:
plural CPUs, wherein when a first CPU of the plural CPUs is a master, the other CPU is a slave;
plural memories provided corresponding to the plural CPUs, the plural memories including a memory that operates and is used for first processing other than processing of the RIP when the master CPU operates, and a memory that operates and is used for processing of the RIP when the slave CPU operates; and
a controller that sequentially switches the CPU to serve as a master of the plural CPUs, then causes the remaining CPU to serve as a slave and sequentially switches the memories used for the first processing and the RIP processing, every time an OS (Operating System) starts.

9. The apparatus according to claim 8, wherein when executing the RIP processing, the controller simultaneously uses the master CPU and the slave CPU and uses the memories corresponding to the master CPU and the slave CPU for RIP operation.

10. The apparatus according to claim 8, wherein when executing the first processing, the controller makes the slave CPU inactive and controls the other memory than the memory used for the first processing of the plural memories, to be inactive.

11. The apparatus according to claim 10, wherein when executing the first processing, the controller causes the slave CPU to be in sleep state and controls the other memory than the memory used for the first processing of the plural memories, to be in a power-off or power-down mode.

12. The apparatus according to claim 8, wherein the controller sequentially switches the CPU to serve as the master every time power is turned on.

13. The apparatus according to claim 8, further comprising a non-volatile memory that stores master and slave states of the plural CPUs and state of use of the plural memories every time the OS (Operating System) is stopped,
wherein the controller sequentially switches the CPU to serve as the master every time the OS is started, in accordance with information stored in the non-volatile memory.

14. A control method for an electronic equipment comprising:
having plural CPUs, and when a first CPU of the plural CPUs is a master, causing the other CPU to operate as a slave;
having plural memories corresponding to the plural CPUs, and executing first processing by using a memory corresponding to the master CPU when the master CPU operates;
executing second processing by using a memory corresponding to the slave CPU when the slave CPU operates; and
sequentially switching the CPU to serve as a master of the plural CPUs, then causing the remaining CPU to serve as a slave and sequentially switching the memories used for the first processing and the second processing, every time an OS (Operating System) starts.

15. The method according to claim 14, wherein when executing the first processing, the slave CPU is made inactive and the other memory than the memory used for the first processing of the plural memories is controlled to be inactive.

16. The method according to claim 15, wherein when executing the first processing, the slave CPU is caused to be in sleep state and the other memory than the memory used for the first processing of the plural memories is controlled to be in a power-off or power-down mode.

17. The method according to claim 14, wherein the CPU to serve as the master is sequentially switched every time power is turned on.

18. The method according to claim 14, wherein master and slave states of the plural CPUs and state of use of the plural memories are stored in a non-volatile memory every time the OS (Operating System) is stopped, and
the CPU to serve as the master is sequentially switched every time the OS is started, in accordance with information stored in the non-volatile memory.

19. The method according to claim 14, wherein a first program to execute the first processing is saved in a first ROM,
a second program to execute the second processing is saved in a second ROM, and
the programs saved in the first and second ROMs are loaded to the plural memories, respectively, when executing the first processing and when executing the second processing.

20. The method according to claim 14, wherein the plural CPUs include first and second CPUs,
the plural memories include first and second memories provided corresponding to the first and second CPUs,
a master-slave relation between the first and second CPUs is alternately switched every time the OS starts, and
the first and second memories corresponding to the master CPU and the slave CPU are switched in the use for the first processing or the second processing.
